(19) United States
(12) Patent Application Publication
(10) Pub. No.: US 2006/0160239 A1
(43) Pub. Date: Jul. 20, 2006

(54) Method of measuring a level of contamination in a chemical solution and systems thereof

(76) Inventors: Sung-Jae Lee, Gyeonggi-do (KR); Yang-Koo Lee, Gyeonggi-do (KR); Jae-Seok Lee, Seoul (KR); Sang-Mun Chon, Gyeonggi-do (KR); Pil-Kwon Jun, Kyungki-Do (KR); Dong-Won Hwang, Kyungki-Do (KR)

Correspondence Address: MARGER JOHNSON & MCCOLLOM, P.C., 210 SW MORRISON STREET, SUITE 400, PORTLAND, OR, 97204, US

(21) Appl. No.: 11/193,301

(22) Filed: Jul. 29, 2005

(30) Foreign Application Priority Data
Jan. 14, 2005 (KR) 2005-3761

(51) Int. Cl. B08B 7/04; C23G 1/00

(52) U.S. Cl. 436/164; 134/2; 134/18

(57) ABSTRACT

In one embodiment, a sample of chemical solution is provided. A first optical property of the sample is detected at a first wavelength and an expected optical property is predicted at a second wavelength, using the first optical property. A second optical property of the sample is detected at the second wavelength. The second optical property is compared with the expected optical property to measure a contamination level of a particular contaminant in the sample.

### CROSS-REFERENCE TO RELATED APPLICATION

The present application claims the priority of Korean Patent Application No. 2005-3761, filed on Jan. 14, 2005, in the Korean Intellectual Property Office. The disclosures of all of the above applications are incorporated herein in their entirety by reference.

### BACKGROUND OF INVENTION

1. Field of the Invention

The present invention generally relates to methods of measuring a level of contamination in a chemical solution such as a cleaning solution and systems thereof.

2. Description of Related Art

In many product manufacturing processes, accurately measuring a level of contamination in a chemical solution is essential for successfully manufacturing various products. For example, during the fabrication of semiconductor devices, semiconductor wafers are cleaned before and after fabrication steps such as diffusion, photolithography, and deposition are performed. During the cleaning process, contaminants such as metals, particles, and/or organic materials generated from the wafers during the fabrication processes can be removed. Typically, the contaminants remaining on the wafers are removed in a cleaning bath filled with a cleaning solution.

After a plurality of cleaning operations, contaminants that have accumulated in the chemical solution may in turn contaminate the wafers. These contaminants may migrate to the inner portion of the wafers from the edge portion thereof, thereby degrading the device characteristics or causing device failures. For example, the contaminants might induce oxidation, reduction and/or pitting on a wafer surface. Contamination from metals such as aluminum (Al) or transition metals such as Fe, Ni and so on can be particularly damaging to semiconductor devices. As a result, the yields of semiconductor devices fabricated using such a contaminated wafer due to the contaminated chemical solution can be significantly compromised.

Accordingly, there has been an urgent need for accurately measuring a level of contamination of the cleaning solution, thereby to avoid contamination of wafers cleaned therein.

However, conventional methods of measuring a level of contamination may be inaccurate as these methods can be undesirably affected by various sources of error in contamination measurements. Embodiments of the invention address these and other disadvantages of the conventional art.

### SUMMARY

In one embodiment, for measuring contamination, a sample of chemical solution is provided. A first optical property of the sample is detected at a first wavelength and an expected optical property is predicted at a second wavelength, using the first optical property. A second optical property of the sample is detected at the second wavelength. The second optical property is compared with the expected optical property to measure a contamination level of a particular contaminant in the sample.

With the embodiments of the present invention, it is now possible to accurately measure a level of contamination by removing measurement error sources such as bubbles or pulsation before measurements and by adjusting or calibrating measurement results to exclude measurement noise due to a composition ratio variation of the chemical solution. Therefore, it is now possible to properly measure the contamination level of the cleaning solution, thereby increasing device yield and reducing device fabrication costs.

### BRIEF DESCRIPTION OF THE DRAWINGS

The aspects and advantages of the present invention will become more apparent with the detailed description of the exemplary embodiments with reference to the attached drawings.

FIG. 1 is a graph illustrating the relationship between light absorbency (vertical axis) and contamination concentration (horizontal axis) of a certain chemical solution to illustrate concepts of some embodiments of the present invention.

FIG. 2 is a graph illustrating a variation in light absorbency according to a composition ratio variation and a contamination level of a chemical solution (vertical axis) as a function of time (horizontal axis).

FIG. 3 is a system block diagram illustrating a system including plural subsystems for measuring a level of contamination in a chemical solution according to some embodiments of the present invention.

FIGS. 4 and 5 are schematic diagrams illustrating the operations of a first pressurization part and a first bubble removal part for removing bubbles from the system disclosed in FIG. 3 according to some embodiments of the present invention.

FIG. 6 is a schematic diagram of a pulsation absorption apparatus illustrating the operation thereof in accordance with some embodiments of the present invention.

FIG. 7 is a schematic diagram illustrating an optical spectrometer for measuring an optical property of a sample of a chemical solution to measure a contamination level of the chemical solution.

FIG. 8 is a graph illustrating the correlation between absorbency values of light (vertical axis) at a first wavelength and those of light at a second wavelength as a function of a pH value (horizontal axis).

FIG. 9 is a flowchart illustrating the analysis method in accordance with one embodiment of the present invention.

### DETAILED DESCRIPTION

In the following description, several exemplary embodiments of the invention are described. These exemplary embodiments are not intended to be limiting in any way, but rather to convey the inventive aspects contained in the exemplary embodiments to those skilled in this art. Those skilled in this art will recognize that various modifications may be made to the exemplary embodiments without departing from the scope of the invention as defined in the attached claims.

For accurately measuring a level of contamination in the cleaning solution, Assignee of the present application proposed methods of measuring a contamination level of a cleaning solution in the U.S. patent application Ser. No. 10/952,510 entitled “Methods of Monitoring Cleaning Solutions and Related Systems and Reagents,” filed on Sep. 28, 2004, the entire contents of which are incorporated herein by reference. By these methods, a measuring reagent is mixed with the cleaning solution to provide a mixture, and a property of the mixture is measured by transmitting light through the mixture at a particular wavelength and measuring an absorbency of the light that exits the mixture for measuring a level of contamination as explained further below. The absorbency may also be referred to as signal intensity. An absorbency and intensity of light passing through the mixture are technically inverse of one another, but the terms used herein, i.e., the absorbency and the signal intensity, are used interchangeably to refer to a measure of the amount of light absorbed by or passed through the mixture.

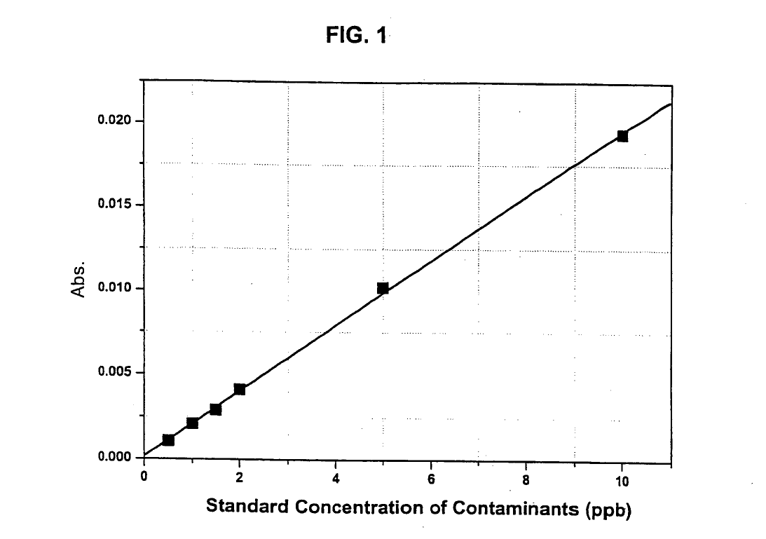

As shown in FIG. 1, the signal intensity, i.e. absorbency value, is directly proportional to the amount of the contaminants because this optical property is dependent on the concentration of metal in the cleaning solution, assuming there is no composition ratio variation. In particular, the reagent reacts with ions of the contaminating metal to form a complex compound. An increase in metal contamination in the cleaning solution in turn results in an increased concentration of the resulting complex compound in the mixture and an increased light absorbency of the mixture. Accordingly, the amount of contamination may be determined by measuring the extent of absorbency or signal intensity. For example, as shown in FIG. 1, if there is a contamination of 0.5 ppb, the absorbency value is 0.001 abs. If there is a contamination of 1 ppb, the absorbency value is 0.002 abs.

Applicants of the present application have discovered that, even with these methods, various measurement error sources, e.g. bubbles contained in the liquid sample and a pulsation resulting from the use of a pump for supplying the liquid sample, can undesirably affect the measurement results for measuring a contamination level. In other words, the measurement results, e.g., the absorbency values, may contain an error value resulting from these error sources. For these reasons, to accurately measure the level of contamination in the liquid sample, these error sources need to be removed before actual measurements are performed.

Further, applicants have discovered that the measurement results may also contain a noise value caused by a composition ratio variation, that is, a change in relative concentrations of the components that comprise the cleaning solution. There are various factors that may cause this composition ratio to change, and this ratio may be generally a function of time. In particular, in the case of cleaning solutions such as an SC1 solution consisting of NH₄OH, H₂O₂ and H₂O, a component such as NH₄OH can be evaporated during the cleaning process and the resulting variation in the composition ratio can act as a significant error source, preventing an accurate measurement of a contamination level in the cleaning solution. Unfortunately, the composition ratio variation cannot be physically removed unlike the other error sources such as bubbles or a pulsation.

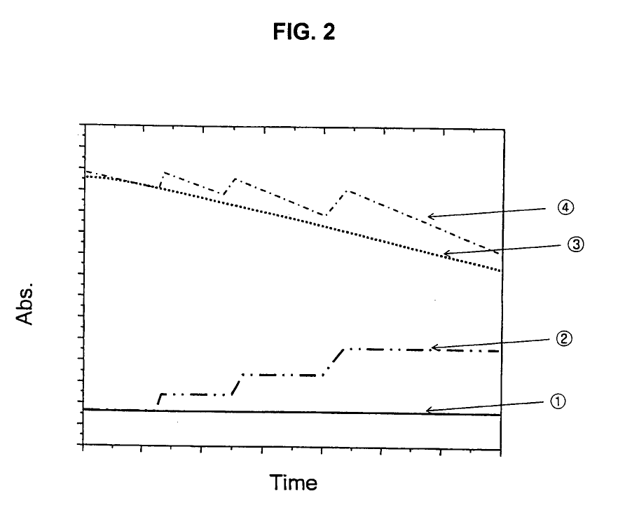

Therefore, there is a need for a method of calibrating or correcting measurement results to extract a true value, i.e., a level of contamination only, from the measurements that include an error value in addition to the true value. This is further explained by reference to FIG. 2, in which a variation in light absorbency (vertical axis) according to a composition ratio variation and a contamination level of the chemical solution is graphed as a function of time (horizontal axis). The chemical solution in the bath may be replaced every four hours. The values shown in FIG. 2 are for explanation only. Actual changes in absorbency values can be greater or smaller than the values shown in FIG. 2, depending on the level of contamination or composition ratio variation. For example, if the extent of the contamination level is greater than that of the composition ratio variation, the changes in absorbency values can be greater than in FIG. 2.

Referring to FIG. 2, for line \textcircled{1}, data is obtained when there is no composition ratio variation, using an un-contaminated sample. For line \textcircled{2}, data is obtained when there is no composition ratio variation, but using a contaminated sample. For line \textcircled{3}, data is obtained when there is a composition ratio variation, but using an un-contaminated sample. Lastly, for line \textcircled{4}, data is obtained when there is a composition ratio variation, using a contaminated sample.

In the SC1 liquid sample without bubbles, pulsation, composition ratio variation, or contamination, a particular absorbency value unique to SC1 can be obtained using a suitable reagent at the wavelength of, for example, 320 nm. This can be referred to as a normal absorbency value of SC1. Any deviation from this normal absorbency value can be referred to as a noise value. In FIG. 2, line \textcircled{1} represents a normal absorbency value, whereas noise values are included in the other lines of the plot.

As discussed, in line \textcircled{1}, absorbency values represent states where there are no contamination and composition ratio variations. These values may be obtained by subtracting the absorbency values due to the composition ratio variation from the total absorbency values of line \textcircled{3} (In practice, however, there is normally a change in the absorbency because there is typically a composition ratio variation in the chemical solution as time passes).

As for line \textcircled{2}, absorbency values increase over time as the contaminants typically accumulate in the bath containing the chemical solution as time passes. These values may be obtained by subtracting the absorbency values due to the composition ratio variation from the total absorbency values of line \textcircled{4} as explained further below.

On the other hand, for example, in the case of an SC1 solution, the total absorbency values of the samples identified by line \textcircled{3} decrease as the level of composition ratio variation increases over time, as explained further with reference to Table 1 below.

The total absorbency values of line \textcircled{4} is typically greater than those of line \textcircled{2} or line \textcircled{3}, because the data is influenced by both the composition ratio variation and the contamination itself. In other words, the absorbency values of line \textcircled{4} are higher than the true value, i.e., the absorbency values of line \textcircled{2}, due to noise resulting from the composition ratio variation. During the measurements, the absorbency values of line \textcircled{3} are undesirably added to the absorbency values of line \textcircled{2}, resulting in the absorbency values of line \textcircled{4}.

For these reasons, to accurately measure the level of the contamination, the noise value resulting from the composition ratio variation needs to be subtracted from the actual measurements to compensate for this variation. If the composition ratio of the chemical solution does not change, there is no need for a calibration or compensation for the composition ratio variation (noise value).

Therefore, embodiments of the present invention concern removing the noise values resulting from measurement error sources such as bubbles and the pulsation, and further excluding the noise value resulting from the composition ratio variation. In this way, the level of contamination of a cleaning or chemical solution can be accurately measured.

### System for Measuring a Contamination Level in a Chemical Solution

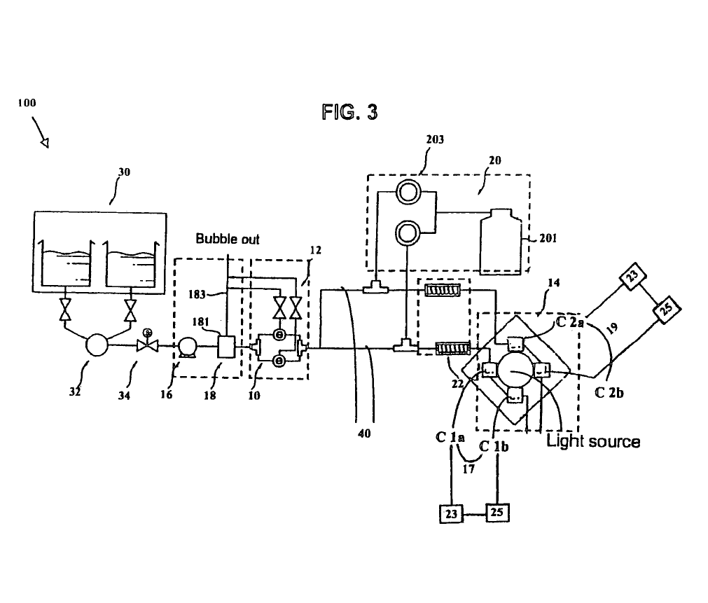

FIG. 3 illustrates a system 100 for measuring a level of contamination in a chemical solution such as a wafer cleaning solution including, but not limited to, diluted HF, NH₄OH/H₂O₂/H₂O (SC1), HCl/H₂O₂/H₂O, HNO₃/HF/H₂O, HF/H₂O₂, HF/NH₄/H₂O₂, HFNH₄, HF/HNO₃/CH₃COOH, H₃PO₄, HNO₃/H₃PO₄/CH₃COOH, and/or ultra de-ionized water in accordance with one embodiment of the present invention. Normally, these are alkaline solutions, but they may become acid solutions if there is a composition ratio variation (change of pH values).

Referring to FIG. 3, the system 100 includes a liquid bath 30 comprising reservoirs each containing the chemical solution for supplying a sample of the chemical solution according to an embodiment of the present invention. Although two reservoirs are shown in FIG. 3, one skilled in the art will appreciate that the invention may include one or more reservoirs depending on the needs. If the system 100 requires more than one reservoir, a selection valve 32 can be included for selectively conveying the sample. The system 100 can include an urgency lock 34 valve in case of an emergency to stop the flow of the liquid sample.

The system 100 can also comprise a first bubble removal part 12, a first pressurization part 10, a second bubble removal part 18 (an exhaust line 183 coupled to a storing space 181), a second pressurization part 16, one or more flow lines 40, which may be a capillary type for increasing the flow velocity of the liquid sample, one or more pulsation absorption apparatuses 22, an analytic part 14, a reagent part 20, which may include reagent storage 201, and one or more reagent suppliers 203. Further details about the above parts are explained as follows.

Removing Bubbles Before Measurement

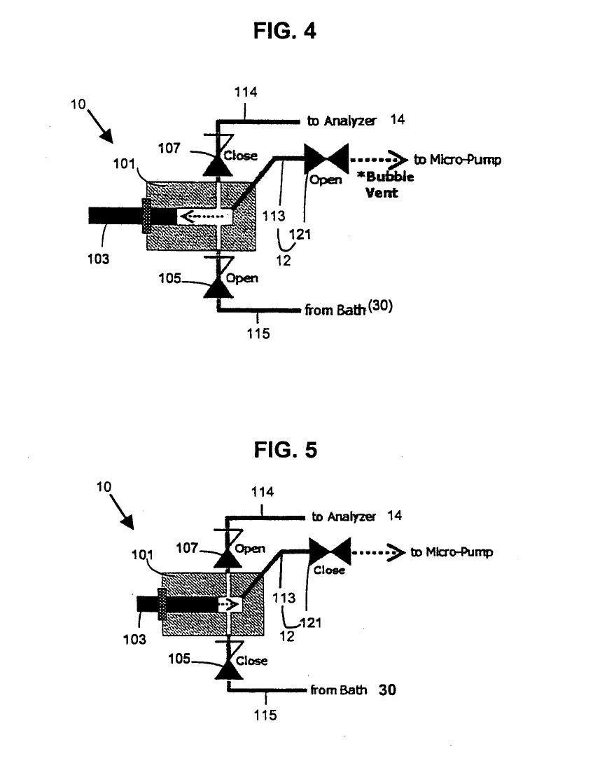

Referring to FIG. 4, the first pressurization part 10 can comprise a cylinder 101, a piston 103, a first valve 107, a second valve 105 and a switching valve 121 in accordance with some embodiments of the present invention. The piston 103 moves horizontally inside of the cylinder 101 to thereby remove small bubbles, for example, having a size of less than about 0.1 mm³, inadvertently contained in the sample of the chemical solution.

The first bubble removal part 12 is in fluid communication with the cylinder 101 to remove the small bubbles therefrom. The first bubble removal part 12 can comprise a by-pass line 113 connected to an exhaust pump (not depicted) for efficiently removing the bubbles from the first pressurization part 10. The switching valve 121 can also be included onto the by-pass line 113. The cylinder 101 can have an outflow line 114 including the first valve 107 in one side of the cylinder 101. Further, an inflow line 115 on the side opposite the outflow line 114 is in fluid communication with the cylinder 101 and includes the second valve 105 to control the flow of the sample to the analytic part 14.

FIG. 4 also illustrates the bubble removal operation. In detail, the first valve 107 is closed while the second valve 105 and the switching valve 121 are opened. When the interior space of the cylinder 101 is decompressed by movement of the piston 103 in the direction of the arrow, a new liquid sample is supplied into the cylinder 101 from the bath 30. Any bubbles that are found in the liquid sample are moved into the interior space of the cylinder 101 adjacent the by-pass line 113. At the same time, bubbles may be removed outwardly through the by-pass line 113 of the first bubble removal part 12.

Now referring to FIG. 5, the second valve 105 and the switching valve 121 are closed while the first valve 107 is opened. The liquid sample in the cylinder 101 is pressurized by compressing an interior space of the cylinder 101 at a first pressure by moving the piston 103 in the direction of the arrow. The first pressure applied with the first pressurization part 10 can be in the range of about 300 to about 500 psi. Preferably, the first pressure can be in the range of about 350 to about 450 psi and, more preferably, about 400 psi. This is because if the pressure is less than about 300 psi, the liquid sample cannot flow quickly and, as a result, bubbles can be generated undesirably. On the other hand, if the pressure is greater than about 500 psi, the first pressurization part 101 can be damaged by too much pressure.

The pressurized liquid sample may be exhausted from the cylinder 101 through the outflow line 114. Accordingly, the sample having bubbles substantially removed therefrom can be sent to the analytic part 14 for measuring a contamination level of the sample.

Referring again to FIG. 3, the system 100 may include a second pressurization part 16 and a second bubble removal part 18 to additionally remove the relatively larger bubbles from the sample for an accurate analysis. These relatively larger bubbles may have a size greater than or equal to about 0.1 mm³, for example. The second removal part 18 is preferably disposed between the first and second pressurization parts 10, 16. The second removal part 18 can comprise a store space 181 to receive a pressurized sample from the second pressurization part 16 and an exhaust line 183 connected to a top surface of the store space 181. The liquid sample is pressurized and transferred to the second bubble removal part 18 by the second pressurization part 16 at a second pressure in the range of about 40 to about 60 psi, preferably in the range of about 45 to about 55 psi, and more preferably about 50 psi, before the liquid sample is transferred to the first pressurization part 10. The bubbles separated from the liquid sample by the pressurization are directed to the top area of the store space 181 and are outwardly exhausted through the exhaust line 183 having an open switching valve (not depicted). Accordingly, the bubbles, i.e., one of the measurement error sources, can be substantially removed.

Mixing a Measuring Reagent with the Sample

Referring back to FIG. 3, the system may also include the reagent part 20 for more efficiently and accurately measuring the contamination level of the liquid sample. As briefly described above, according to some embodiments of the invention disclosed in the above mentioned application by assignee, the reagent is mixed with the liquid sample of the cleaning solution to provide a mixture, and a property of the mixture is measured using a complex compound formed by the reaction between the reagent and contaminants such as a metal. Similarly, in one embodiment of the present invention, the reagent part 20 is configured to provide the reagent in the flow line 40 to be mixed with the liquid sample. In this case, the reagent storage 201 can be included for storing the reagent and the reagent supply part 203 can also be included for supplying the reagent in the flow line 40 to be mixed with the liquid sample. The reagent part 20 can optionally include a piston pump (not depicted) including a piston to pressurize the reagent.

Pulsation Removal

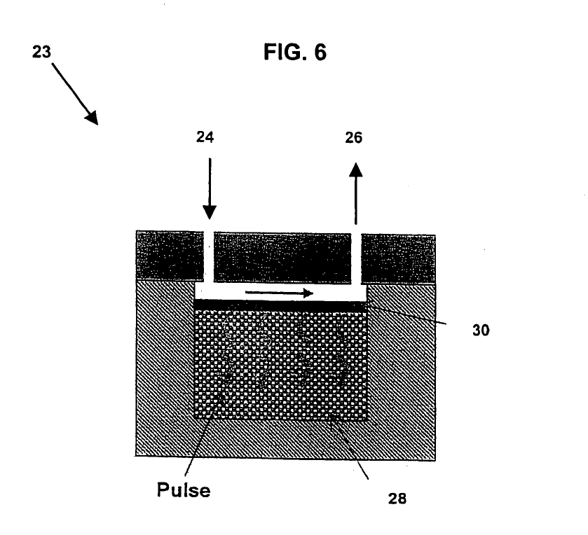

Referring to FIGS. 3 and 6, according to some embodiments of the invention, the system 100 may include a pulsation absorption apparatus 22 for decreasing the measurement error source due to the pulsation generated by, for example, discontinuous flow of the liquid sample resulting from the operation of the piston or pump. The pulsation absorption apparatus 22 can take the form of a pulsation absorption filter 23 shown in FIG. 6 for removing the pulsation in the liquid sample. In the pulsation absorption filter 23, the liquid sample with pulsation is introduced into the filter 23 through an inlet 24 and flows along a disk such as a Teflon disk 30. Then, an absorber 28 preferably formed of an elastomer dampens or absorbs the pulsation, thereby substantially removing the pulsation from the liquid sample, which is exhausted through an outlet 26.

Analytical Parts for Calibrating the Measurement Result, I.e. Compensating for a Noise Resulting from Composition Ratio Variation

The system 100 may include the analytic part 14 for analyzing the liquid sample preferably after removing the error sources due to bubble and/or pulsation from the liquid sample as discussed above. In further detail, the liquid sample flows through the analytic part 14 that may include a first analytic part 17 composed of, for example, first and second analyzers C1a, C1b, optionally connected to one of the first pressurization parts 10, one of the reagent supply parts 203, and one of the pulsation parts 22.

The liquid sample can be made sequentially to flow through the first analyzer C 1a and the second analyzer C1b, or vice versa. However, one skilled in the art will understand that the liquid sample may concurrently flow through the first and second analyzers C1a, C 1b (not illustrated in the drawing), depending on the application. Also, one skilled in the art will appreciate that the analytic part 14 can comprise one or more analytic parts, depending on the application or signal controlling techniques. For example, the analytic part 14 may further include a second analytic part 19 composed of third and fourth analyzers C2a, C2b, optionally connected to other first pressurization parts 10, other reagent supply parts 203, and other pulsation parts 22. The third and fourth analyzers C2a, C2b have substantially the same or similar functions and/or structures as that of the first and second analyzers C1a, C1b.

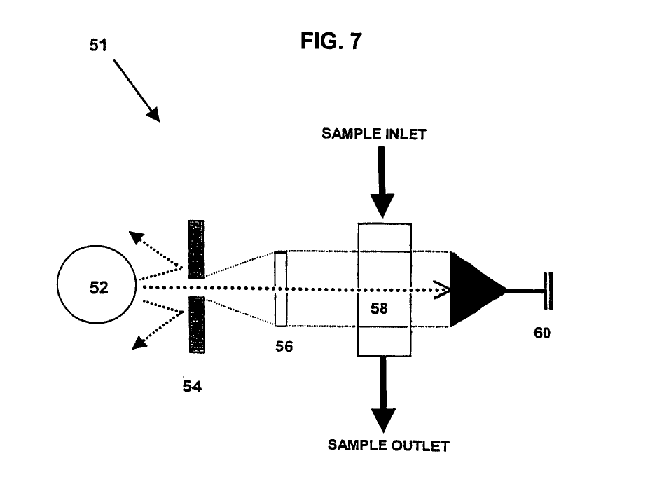

Referring to FIGS. 3 and 7, the first and second analyzers C1a and/or C1b (or the third and fourth analyzers C2a and/or C2b) each preferably comprise a spectroscopic sample analyzer such as an optical spectrometer 51 with a light source 52, which is preferably a visible or ultraviolet (UV) light source. Optionally, the light source 52 may be a single light source that can be used for one or more analyzers. The optical spectrometer 51 can include a band-pass filter 54 which allows only light having a particular wavelength to pass therethrough, a quartz lens 56, a flow cell 58 and a photodiode detector 60, e.g., a single photodiode array detector to measure an absorbency of the transmitted light passing through the liquid sample. For example, the band-pass filter 54 can comprise magnesium oxide (MgO) adapted to allow only light having a wavelength of about 320 nm to pass therethrough. Also, the band-pass filter 54 can comprise quartz adapted to allow only light having a wavelength of about 520 nm to pass therethrough. In addition, the band-pass filter 54 may comprise quartz coated with a suitable coating material to allow only light having a wavelength of about 580 nm to pass therethrough. One skilled in the art will be able to select the band-pass filter depending on wavelengths to be used for their specific application.

The liquid sample (indicated by the downward arrows) flowing through the flow cell 58 is therefore irradiated by the light at the particular wavelengths.

In further detail, the first analyzer C1a is configured to measure a first optical property, e.g., an absorbency value including a noise value resulting from a composition ratio variation of the (uncontaminated) liquid sample at a first wavelength, if any. The system 100 then calculates or predicts an expected optical property at a second wavelength from the first optical property as explained further below. Here, the expected optical property corresponds to an absorbency value including a noise value resulting from the composition ratio variation of the liquid sample at the second wavelength. For this, the first analyzer C1a might be coupled with a predictor 23, e.g., a conventional microprocessor, for calculating the expected optical property at the second wavelength from the first optical property using the correlation data in Table 1 below. In this case, the photodiode detector 60 of the first analyzer C1a can send a detected signal to the predictor 23 for calculation. Alternatively, this process can be done manually.

The second analyzer C1b is configured to measure a second optical property of the sample, e.g., an absorbency value including noise values resulting from the composition ratio variation as well as contamination, if any, at the second wavelength. With these data, an accurate level of contamination of the chemical solution can be measured as explained further below.

### Selection of Particular Wavelengths for a Particular Contaminant in a Particular Chemical Solution

Applicants have discovered that an absorbency value of light passing through the SC1 liquid sample exhibits the highest, i.e., most apparent, absorbency, at the wavelength of about 320 nm compared to when other wavelengths such as about 100 nm or about 700 nm are used. (Absorbency measured at these wavelengths other than about 320 nm is much smaller or negligible.) Further, the absorbency measured at about 320 nm substantially corresponds to the normal absorbency value of the SC1 solution in addition to the noise value resulting from the composition ratio variation, if any.

At the same time, applicants have determined that absorbency measured at the wavelength of about 320 nm is substantially “insensitive” to contaminants such as transition metals, including chromium, iron, and nickel and so on, as well as Al, W, Ti in the sample. That is, the absorbency of light having a wavelength of about 320 nm transmitted through the liquid sample containing contaminants such as transition metals or Al is very small or inconspicuous, thus the use of the term “insensitive.” For these reasons, the wavelength of about 320 nm can be used to measure an absorbency value of the SC1 liquid sample having a composition ratio variation, or the SC1 liquid sample without the composition ratio variation, while not including the absorbency value resulting from contaminants.

On the other hand, applicants have selected the wavelength of about 520 nm because the absorbency value of the light measured at the wavelength of about 520 nm corresponds to the normal absorbency value of the SC1 solution in addition to the noise value due to a level of contamination as well as a composition ratio variation of the liquid sample. For example, in the case of transition metals or Al, an absorbency value is negligible at about 320 nm, but exhibits a highest, i.e., most apparent, value at about 520 nm for transition metals and about 580 nm for group III metals such as Al. Also, in the case of SC1, at the wavelengths of about 520 nm or about 580 nm, measurement values include not only an absorbency resulting from a composition ratio variation but also an absorbency resulting from the presence of contaminants such as transition metals or Al, respectively.

One skilled in the art will appreciate that wavelengths of electromagnetic radiation, e.g., visible or UV light, can be selected for detection of other contaminants in a certain chemical solution using the same principles described above. In this respect, the first wavelength can be any wavelength particularly sensitive to or effective for the detection of noises that mainly result from a composition ratio variation of a particular cleaning solution. Also, the second wavelength can be selected so that the absorbency corresponds not just to the composition ratio variation, but also to a contamination level of the particular contaminant. As discussed above, in the case of transition metals, about 520 nm is selected to be the second wavelength and in the case of group III metals such as Al, about 580 nm is selected to be the second wavelength. This aspect of the present invention is used for embodiments of the present invention as further described below.

Correlation Data Between a First Optical Property Measured at a First Wavelength to Predict an Expected Optical Property at a Second Wavelength from the First Optical Property

TABLE 1

| | | | | | Delta |
|---|---|---|---|---|---|
| pH | 320 nm (A) | 520 nm (B) | 580 nm (C) | Delta (A-B) | (A-C) |
| 3 | 0.5012 | 0.2513 | 0.0800 | 0.2499 | 0.4212 |
| 4 | 0.5513 | 0.3012 | 0.1302 | 0.2501 | 0.4211 |
| 5 | 0.6010 | 0.3510 | 0.1805 | 0.2500 | 0.4205 |
| 6 | 0.6513 | 0.4011 | 0.2304 | 0.2502 | 0.4209 |
| 7 | 0.7011 | 0.4512 | 0.2810 | 0.2499 | 0.4201 |
| 8 | 0.7511 | 0.5013 | 0.3307 | 0.2498 | 0.4204 |
| 9 | 0.8012 | 0.5512 | 0.3811 | 0.2500 | 0.4201 |
| 10 | 0.8513 | 0.6011 | 0.4302 | 0.2502 | 0.4211 |
| 11 | 0.9011 | 0.6510 | 0.4809 | 0.2501 | 0.4202 |
| 12 | 0.9514 | 0.7016 | 0.5306 | 0.2498 | 0.4208 |
| AVG | | | | 0.25 | 0.42 |

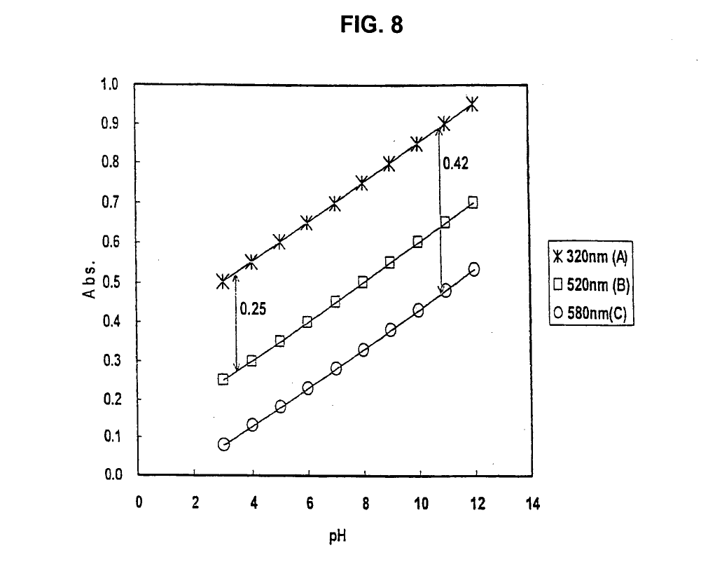

Table 1 above is the correlation data for predicting the expected optical property at the second wavelength according to a composition ratio variation of the chemical solution in accordance with an embodiment of the present invention, along with FIG. 8. In Table 1, a variation of pH represents the variation of the composition ratio of the chemical solution such as SC1. In the case of SC1, the pH of the liquid sample with no composition ratio variation is 11. If there is a composition ratio variation, the pH value changes, e.g., it decreases. Also, if the chemical solution is condensed, i.e., H₂O being evaporated, pH is increased to 12, for instance.

Applicants have also discovered that there is a correlation between the absorbencies of light at a particular wavelength and light at another wavelength throughout pH ranges as shown in FIG. 8. In particular, FIG. 8 shows that absorbency values according to the pH variation of the chemical solution at the wavelength of 320 nm have a constant difference value (Delta (A−B) in table 1) as compared to those at 520 nm. Similarly, FIG. 8 also shows that absorbency values according to the pH variation of the chemical solution at the wavelength of 320 nm have a constant difference value (Delta(A−C) in table 1) as compared to those at 580 nm.

Table 1 is prepared based on these correlation data regarding the relationship of absorbency values at different wavelengths according to the pH variation of the chemical solution. For example, as shown in Table 1 and FIG. 8, based upon the experiments using SC1, assuming substantially no contamination, the average difference value between light absorbencies at the wavelength of about 320 nm and the wavelength of about 520 nm is about 0.25 (average value of delta (A−B) in Table 1). (Also, the average difference value between light absorbencies at about 320 nm and about 580 nm is about 0.42 (average value of delta (A−C) in Table 1). Thus, if the absorbency of the light through the liquid sample is measured at the wavelength of about 320 nm, say 0.9011 at a pH of 11, then the absorbency of the light through the liquid sample at the wavelength of about 520 nm can be predicted as 0.6510 at a pH of 11.

In further detail, as discussed above, if the pH level of an SC1 sample is 11, it can be said that there is no composition ratio variation. If H₂O evaporates from the SC1 solution, the pH value is increased to 12 and becomes more basic, and if NH₄OH evaporates, the pH value is decreased to 10, and becomes more acidic. If the pH value is 11, a normal absorbency value, i.e., the absorbency value not influenced by noise, can be obtained. In the case of SC1, the normal absorbency is 0.9011, a higher value corresponding to a wavelength of 320 nm and 0.6510, a lower value corresponding to a wavelength of 520 nm (for transition metals). Although the absorbency value at 520 nm is not as high as the absorbency value at 320 nm, but it is high enough for measuring a contamination level.

As the pH values of the chemical solution change according to the composition ratio variation, so do the absorbency values. Although applicants do not wish to be held to a particular theory of operation, applicants believe that, for example, as NH₄OH of SC1 evaporates over time, SC1 becomes more acidic, thus reducing the total absorbency values as shown in FIG. 2 or Table 1. Applicants also believe that this can be attributed to the properties of SC1. (For other chemical solutions, however, the total absorbency value may increase as the pH decreases) In other words, in the case of SC1, as the pH decreases, the noise value due to the composition ratio variation reduces the total absorbency value as shown in Table 1. (The noise value due to the composition ratio variation is a negative or minus factor for the normal absorbency value.) Conversely, as the pH increases, the total absorbency value can increase because the noise value due to the composition ratio variation becomes a positive factor for the normal absorbency value.

As a result, for certain chemical solutions such as SC1, absorbency values at various wavelengths such as 320 nm and 520 nm (for transition metals) can be obtained throughout the pH ranges (and the difference between them is typically 0.25 abs for SC1). The same is also true for other wavelengths such as 320 nm and 580 nm (for Al), depending on the contaminants being targeted.

Using these results, one can predict an expected property, e.g., an absorbency of the light through the liquid sample “with substantially no contamination” at a particular wavelength, e.g., about 520 nm, from the absorbency measured at the wavelength of about 320 nm using, for example, Table 1. In other words, for SC1, at the wavelength of 320 nm, the absorbency value unaffected by the contamination can be obtained and used to predict absorbency values at different wavelengths such as 520 or 580 nm, depending on contaminations being targeted, using the data in Table 1, for instance.

Therefore, by actually measuring the absorbency value at 520 (or 580) nm and comparing the actual absorbency value with the predicted absorbency value, one can determine whether or not there is a contamination of particular contaminants. The predicted absorbency value is an absorbency value without a contamination. So if there is a contamination, then the actual measurement is higher than the predicted absorbency value to the extent of the contamination level. In this case, the second wavelengths of 520 and 580 nm are selected for transition metals and Al, respectively. However, one skilled in the art will easily select other wavelengths for other contaminants using the principles described above.

Those of skill in the art will appreciate that the right two columns of Table 1 illustrate various deltas or differences (A−B or A−C) resulting from subtraction according to the various wavelengths of light and the various pH values represented in the table 1. Those of skill will appreciate that the bottom rows of Table 1 indicate the average deltas (AVG).

Measuring a Level of Contamination Using the Correlation Data, a First Optical Property at a First Wavelength and a Second Optical Property at a Second Wavelength, from Table 1

As discussed above, an absorbency value at the wavelength of about 520 nm may include a noise value due to the composition ratio variation plus a noise value resulting from a contamination. Also, the wavelength of about 320 nm can be used to measure the absorbency of the SC1 liquid sample having a composition ratio variation, without the absorbency value resulting from contaminants. This is because an absorbency resulting from contaminants may not be measured at the first wavelength.

In particular, to accurately measure the level of contamination, the process begins by measuring a first optical property, e.g., an absorbency, of the SC1 liquid sample using analytic parts 17 or 19 (FIG. 3) at a first wavelength, e.g., about 320 nm. The measured absorbency value represents a normal absorbency value of the SC1 solution plus an absorbency value mainly resulting from a composition ratio variation, if there is any. If there is no composition ratio variation, only a normal absorbency unique to SC1 is measured as an absorbency value.

Next, the expected absorbency value at either about 520 nm for transition metals or about 580 nm for Al is obtained by using the measured first optical property and the correlation data of Table 1. For instance, if the first optical property is 0.9011, the expected optical property at 520 nm is 0.6510, and the expected optical property at 580 nm is 0.4809. If the first optical property is 0.8513, then the expected optical property at 520 nm is 0.6011, and the expected optical property at 580 nm is 0.4302. This process is done manually or by the predictor 23 or any other suitable analogue signal or digital data processor (e.g., microprocessor) coupled to the analytic parts 17 or 19.

Then, a second optical property, e.g., the absorbency is measured at a second wavelength, e.g., about 520 nm for transition metals or about 580 nm for group III metals such as Al using the analytic parts 17 or 19. If there is a contamination of the liquid sample, the second optical property, i.e., the absorbency measured at the wavelengths of 520 or 580 nm, includes a noise value due to the contamination regardless of whether the composition ratio is changed or not.

Next, the expected optical property, e.g., an expected absorbency, is compared with the second optical property measured at about 520 nm (or 580 nm). For example, the contamination level can be obtained by subtracting the expected optical property at about 520 nm from the second optical property at the second wavelength, e.g., about 520 nm, thereby obtaining an accurate contamination level. By way of example, if the expected optical property is 0.6011 at 520 nm and the second (actual) optical property is 0.6511 at 520 nm, the difference 0.05 corresponds to the level of contamination of the sample. This process is performed manually or by the comparator 25 or any other suitable analogue signal or digital data processor (e.g., microprocessor) coupled to the analytic parts 17, or 19. The predictor 23 and/or comparator 25 can be one or more of a general data processor, for example, a microprocessor, a central processing unit (CPU), an arithmetic logic unit, a programmable logic controller (PLC), a programmable logic array (PLA), an analogue computer or any other suitable device known to one skilled in the art. Alternatively, the predictor 23 or comparator 25 may be combined into a single device (not illustrated) performing the functions of both the predictor 23 and comparator 25. In this case, both the first and second analyzers C1a, C1b are coupled to the single predictor/comparator device. Further, the comparator 25 may be a subtractor adapted to subtract the expected optical property from the second optical property and output a corresponding subtraction result, i.e., an absorbency noise value resulting from the contamination.

Therefore, if the liquid sample is contaminated, the difference between the second optical property and the expected optical property corresponds to a contamination level of the liquid sample. This is because the absorbency noise value due to the composition ratio variation, in addition to the normal absorbency value of the SC1 solution (the expected optical property) can be cancelled out from the total absorbency value (the second optical property), which is at least the sum of the normal absorbency value of the SC1 solution, an absorbency noise value due to the contamination, if any, and the absorbency noise value due to the composition ratio variation. If the difference is greater than a certain threshold value, for example, 0.001 abs., it may thus be used to indicate that an allowable level of contamination, e.g., metal contamination, in the cleaning solution has been exceeded.

Then, a warning signal can be generated in various forms, e.g., a warning sound or a visual indication in a monitoring monitor before the level of contamination reaches above a threshold, e.g., before undesirable concentrations of contaminants accumulate in the cleaning solution. At this time, various prescribed corrective actions can be taken in response to the determination besides or instead of providing a warning signal. For example, in the case of a semiconductor wafer cleaning process, among other processes, the cleaning solution may be drained from the bath, to be replaced by a fresh cleaning solution. Or, a wafer cleaning process can be stopped before fresh cleaning solution is replaced in the bath.

Using the embodiments of the present invention, after removing measurement error sources such as bubbles or a pulsation, which can be physically removed, a noise value, e.g., an absorbency value resulting from the composition ratio variation can also be excluded from the measurement results, thereby obtaining an accurate measurement of the level of contamination of the chemical solution.

### Example Analysis Method

According to some embodiments of the present invention, analysis methods using the system illustrated above are explained as follows, by reference again to the system block and schematic diagrams of FIGS. 3 through 7.

A cleaning solution is provided in the bath 30 to clean an object such as a wafer (not shown). Then, a liquid sample of the cleaning solution may be introduced into the second pressurization part 16 through the selection valve 32 and the urgency lock valve 34. The liquid sample is pressurized in the second pressurization part 16 with the pressure of, for example, about 30 psi to about 70 psi, more preferably about 50 psi.

Next, the pressurized liquid sample is supplied into the store space 181 of the second bubble removal part 18. The bubbles, for example, having a size of greater than or equal to about 0.1 mm³, separated from the liquid sample are conveyed to the top area of the store space 181, and a valve (not depicted) included on the exhaust line 183 is opened and the bubbles are outwardly exhausted through the exhaust line 183.

Subsequently, the liquid sample is introduced into the first pressurization part 10. There, the liquid sample is pressurized at a pressure in the range of about 200 psi to about 500 psi. Smaller bubbles having a size of less than about 0.1 mm³ are separated from the liquid sample.

Accordingly, the bubbles can be sufficiently removed by pressurizing the liquid sample using the first and second pressurization parts 10, 16 and the first and second bubble removal parts 12, 18.

The liquid sample flows through one or more flow lines 40. The liquid sample may be respectively mixed in the one or more flow lines 40 with a reagent supplied by one or more reagent supply parts 203. The reagent may be the same or similar to the reagent disclosed in the above-described patent application owned by assignee.

The pulsation phenomenon generated by the flow of the liquid sample may be decreased by one or more pulsation absorption apparatuses 22 formed respectively in the one or more flow lines 40. The liquid sample, having the bubbles and pulsation removed therefrom, is introduced into at least one of the analyzers (C1a, C1b; C2a, C2b) of the analytic part 14.

Subsequently, the analysis can proceed in the one or more other analyzers (C1a, C1b; C2a, C2b) for excluding the noise value due to the composition ratio variation and accurately measuring the contamination level. In particular, a first optical property of the sample is detected by irradiating the sample with electromagnetic radiation at a first wavelength. Then, an expected optical property is predicted at a second wavelength from the first optical property using the correlation data in Table 1. Next, a second optical property of the sample is detected by irradiating the sample with electromagnetic radiation, e.g., light, at the second wavelength. And the second optical property is compared with the expected optical property to measure a contamination level of a particular contaminant. If a value of the contamination level is above a predefined threshold, a contamination indication of the liquid sample can be made using the graph, for example, shown in FIG. 1. For example, in the case of SC1, transition metals or Al, absorbency value of 0.001 or above may indicate contamination of the liquid sample. Optionally, a display device (not shown) can be coupled to the measurement system discussed above and it can provide only an indication whether the measured contamination level is within an acceptable threshold or the contamination level exceeds an acceptable threshold. If there is an indication of contamination, necessary actions such as generating a warning signal or stopping the cleaning can be taken, as discussed above.

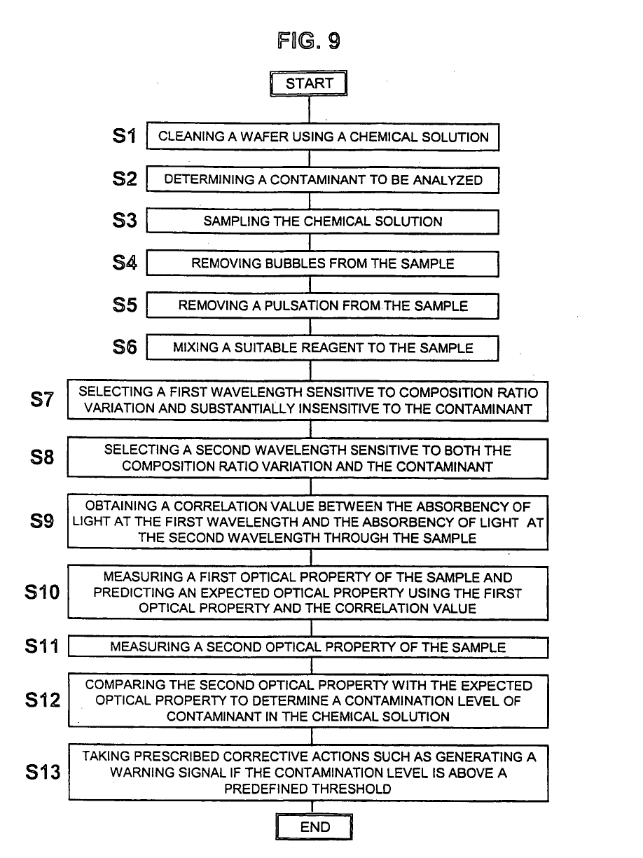

The following is a more detailed overview of the above-described method of measuring contamination according to one embodiment of the present invention, as illustrated in FIG. 9. One skilled in the art will appreciate that some of the steps disclosed in FIG. 9 may not be necessary for practicing embodiments of the present invention. Also, embodiments of the present invention are not limited to the order of the processing steps illustrated in FIG. 9. In other words, some of the processing steps can be performed simultaneously or can be performed using a different sequence depending on the application.

At step S1, a wafer is cleaned using a chemical solution such as SC1. Then, a particular contaminant to be analyzed is determined at step S2. Further, a sample of the chemical solution is provided using conventional techniques including the one described above, at step S3. Then, bubbles from the sample are removed at step S4. Further, at step S5, liquid motion artifacts such as pulsation can be removed from the sample. Then, at step S6, reagents disclosed in U.S. patent application Ser. No. 10/952,510 or suitable reagents may be mixed into the liquid sample depending on the types of contaminants or types of chemical solution before measuring optical properties, e.g., the first optical property.

Also, first and a second wavelength are predetermined at steps S7 and S8. The first wavelength is chosen so that it is sensitive to the composition ratio variation of the liquid sample but insensitive to contaminants. The second wavelength is chosen to be sensitive to both the composition ratio variation and contaminants of the liquid sample.

Next, at step S9, a correlation value between the absorbency at the first wavelength and the absorbency at the second wavelength is obtained by measuring absorbencies at different wavelengths such as about 320 nm (first wavelength), and about 520 or 580 nm (second wavelength), according to the composition ratio variation of the SC1 solution (pH variation). A correlation value can therefore be obtained by determining the difference between light absorbencies according to the variation of the pH of the SC1 solution at the different wavelengths, e.g., that of about 320 nm and that of about 520 nm, e.g., about 0.25 for SC1. One skilled in the art will appreciate that other wavelengths can be used for measuring other types of contaminants using the principles disclosed in the present invention.

At step S10, using the first wavelength, a first optical property, e.g., the absorbency, of the liquid sample is measured. Then, an expected optical property is predicted using the first optical property and the correlation value by, for example, look-up tables such as Table 1. In further detail, absorbency values in the second column of Table 1 correspond to values measured at the first wavelength, e.g., 320 nm, according to the composition ratio variation (pH variation) of the SC1 solution. The absorbency values in the third column correspond to the expected optical properties at the second wavelength of 520 μm, and the absorbency values in the fourth column correspond to the expected optical properties at the second wavelength of 580 nm. For example, in Table 1, at a pH level of 9, if the first optical property value is 0.8012, the predicted optical property value is 0.5512. This predicted value is the absorbency value according to the composition ratio variation of the liquid sample without consideration of the contamination.

Next, at step S11, the absorbency value, say 0.5525, of the liquid sample is actually measured at the second wavelength. Then, at step S12, this actual measurement value is compared with its predicted value, say 0.5512, which was obtained using the correlation value in Table 1. Accordingly, a difference of 0.0013 between the predicted value and the actual measurement value corresponds to the contamination level. If the difference is close to zero or a threshold, then there may be no contamination. Conversely, if the difference is greater than the threshold, e.g., 0.001 abs., a determination of contamination can be made.

According to one aspect of the present invention, the absorbency value of less than 0.001 abs can be regarded as one resulting from the noise inherently existing in the measuring equipment. Therefore, for accurately measuring a contamination level of the liquid sample, the absorbency value inherently resulting from the measuring equipment may be cancelled out from the measurement results, e.g., subtracting 0.001 abs. from the measured contamination level. Therefore, the difference can be further corrected by subtracting an absorbency value inherently resulting from the measuring equipment such as the optical spectrometer 51, e.g., 0.001 abs., thereby obtaining a final result, i.e., a correct level of contamination. Then, various necessary steps such as generating a warning signal can be made at step S 13 as discussed above.

### IN CONCLUSION

Accordingly, with the embodiments of the present invention, it is possible to accurately measure the contamination level by removing measurement error sources such as bubbles or pulsation and/or by excluding noise values resulting from composition ratio variation from the measurement results. Therefore, it is now possible to measure whether contaminants in the cleaning solution are maintained within acceptable thresholds or the contaminants in the cleaning solution exceed acceptable thresholds, which can lead to increased device yields and/or reduced device fabrication costs.

Although the present invention has been described with reference to SC1, transition metals or group III metal contamination, the inventive concept of the present invention is not limited to these embodiments, but can be applied to any other suitable cleaning solution or contaminants such as Ti or W using appropriate irradiation wavelength and other conditions. For example, the first wavelength and second wavelength can be selected for other contaminants and other chemical solution using a suitable reagent and the principles described above. Also, the correlation data therebetween can be prepared using the same principle described above. Further, the principles of the present invention can be applied to any other manufacturing process which requires accurate measurement of a contamination level, not just wafer processing.

Also, various parts of the present invention are merely described and illustrated as being included in the system in order to explain the concept of the present invention. However, embodiments of the present invention are not limited to what is disclosed in the patent application text or drawings. For example, although two analytic parts 17, 19 are shown in the system illustrated in FIG. 3, one or more analytic parts can be included in the system, depending on the needs or applications. In this connection, measuring of the level of contamination of different contaminants can be performed concurrently using the concepts of the present invention.

Reference throughout this specification to “some embodiments,” “one embodiment” or “an embodiment” means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

Having described and illustrated the principles of the invention in several preferred embodiments, it should be apparent that the embodiments may be modified in arrangement and detail without departing from such principles. We claim all modifications and variation coming within the spirit and scope of the following claims.

1. A contamination analyzing method comprising:
providing a sample of chemical solution;
detecting a first optical property of the sample at a first wavelength and predicting an expected optical property at a second wavelength, using the first optical property;
detecting a second optical property of the sample at the second wavelength; and
comparing the second optical property with the expected optical property to determine a contamination level of a particular contaminant in the sample.

2. The method of claim 1, wherein detecting the first optical property comprises measuring an absorbency of the sample by irradiating the sample with electromagnetic radiation at the first wavelength.

3. The method of claim 1, wherein detecting the second optical property comprises measuring an absorbency of the sample by irradiating the sample with electromagnetic radiation at the second wavelength.

4. The method of claim 1, wherein the first wavelength is sensitive to a composition ratio variation of the sample and is substantially insensitive to presence of the particular contaminant in the sample, and wherein the second wavelength is sensitive to both the composition ratio variation of the sample and the presence of the particular contaminant in the sample.

5. The method of claim 1 which further comprises:
selecting the first wavelength such that the first optical property corresponds substantially to a composition ratio variation of the sample; and
selecting the second wavelength such that the second optical property corresponds not only to the composition ratio variation of the sample but also to the presence of contaminant in the sample.

6. The method of claim 1, wherein comparing the second optical property with the expected optical property comprises determining a difference between the expected optical property and the second optical property.

7. The method of claim 6, further comprising:
determining whether the difference between the second optical property and the expected optical property exceeds a predetermined threshold; and
if the difference exceeds the predetermined threshold, generating a warning signal.

8. The method of claim 1, wherein predicting an expected optical property at the second wavelength using the first optical property is performed manually.

9. The method of claim 1, wherein predicting an expected optical property at the second wavelength using the first optical property is performed by a data processor.

10. The method of claim 1, wherein comparing the second optical property with the expected optical property is performed manually.

11. The method of claim 1, wherein comparing the second optical property with the expected optical property is performed by a data processor.

12. The method of claim 1, wherein predicting and comparing are performed using a single data processor.

13. The method of claim 1, wherein detecting a first optical property is performed before detecting a second optical property.

14. The method of claim 1, wherein detecting a first optical property and detecting a second optical property are performed concurrently.

15. The method of claim 1 which further comprises:
reducing a pulsation in the sample before detecting the first optical property and/or the second optical property.

16. The method of claim 1, further comprising removing any first bubbles having a characteristic size of less than a predefined value from the sample before detecting the first optical property and/or the second optical property.

17. The method of claim 16, further comprising removing any second bubbles having a characteristic size of greater than or equal to the predefined value from the sample before detecting the first optical property and/or the second optical property.

18. The method of claim 17, wherein the predefined value is about 0.1 mm³.

19. The method of claim 17, wherein removing the second bubbles is performed before removing the first bubbles.

20. The method of claim 19, wherein the liquid sample is pressurized before removing the second bubbles.

21. The method of claim 20, wherein the liquid sample is pressurized in the range of about 40 psi to about 60 psi.

22. The method of claim 1, which further comprises:
introducing a measuring reagent to the sample before detecting the first optical property and/or second optical property.

23. A contamination analyzing method comprising:
cleaning a wafer using a chemical solution;
determining a particular contaminant to be analyzed;
sampling the chemical solution used to clean the wafer;
selecting a first wavelength sensitive to a composition ratio variation of the sample and substantially insensitive to the presence of particular contaminant in the sample;
selecting a second wavelength sensitive to both the composition ratio variation and the presence of the contaminant;
obtaining a correlation value between absorbency values of light having the first wavelength through the sample and those of light having the second wavelength through the sample;
detecting a first optical property of the sample by irradiating the sample with light at the first wavelength and predicting an expected optical property at the second wavelength, using the first optical property and the correlation value;
detecting a second optical property of the sample by irradiating the sample with light at the second wavelength; and
comparing the second optical property with the expected optical property to determine a contamination level of particular contaminant in the chemical solution.

24. The method of claim 23, further comprising determining whether the contamination level of particular contaminant in the sample is above a predefined threshold to determine a contamination indication of the liquid sample.

25. The method of claim 24, wherein if the contamination level of the particular contaminant in the sample is above the predefined threshold, which further comprises generating a warning signal or stopping the cleaning.

26. The method of claim 24, wherein the threshold is about 0.001 abs.

27. The method of claim 23, wherein comparing the second optical property with the expected optical property comprises determining a difference between the expected optical property and the second optical property.

28. The method of claim 23, wherein comparing the second optical property with the expected optical property comprises subtracting the expected optical property from the second optical property.

29. The method of claim 23, which further comprises:
reducing a pulsation in the sample.

30. The method of claim 23, which further comprises:
removing bubbles having a characteristic size of less than a predefined value from the sample.

31. The method of claim 23, wherein the first wavelength is about 320 nm and the second wavelength is about 520 nm.

32. The method of claim 31, wherein the particular contaminant comprises one or more transition metals.

33. The method of claim 23, wherein the first wavelength is about 320 nm and the second wavelength is about 580 nm.

34. The method of claim 33, wherein the particular contaminant comprises one or more group III metals.

35. The method of claim 34, wherein the particular contaminant comprises aluminum (Al).

36. The method of claim 23, further comprising adding a measuring reagent to the sample.

37. A contamination analyzing method comprising:
providing a sample of a chemical solution;
reducing a pulsation in the sample;
substantially removing bubbles from the sample;
detecting a first optical property of the sample by irradiating the sample with electromagnetic radiation at a first wavelength and predicting an expected optical property at a second wavelength using the first optical property;
detecting a second optical property of the sample by irradiating the sample with electromagnetic radiation at the second wavelength; and
comparing the second optical property with the expected optical property to determine a contamination level of particular contaminant in the sample.

38. The method of claim 37, further comprising introducing a measuring reagent to the sample before detecting the first optical property and/or second optical property.

39. The method of claim 37, wherein the detection of first and second optical properties are performed by a spectroscopic sample analyzer, further comprising subtracting an absorbency due to a noise inherently resulting from use of the spectroscopic sample analyzer from the determined contamination level.

40. A system comprising:
an analyzer configured to detect a first optical property of a liquid sample at a first wavelength, the analyzer being configured further to detect a second optical property at a second wavelength; and
a data processor coupled with the analyzer, the processor adapted to predict an expected optical property at the second wavelength, using the first optical property, and configured to compare the second optical property with the expected optical property to determine a contamination level of particular contaminant in the liquid sample.

41. The system of claim 40, in which the analyzer further comprises:
a first spectroscopic sample analyzer adapted to irradiate the liquid sample with light at the first wavelength; and
a second spectroscopic sample analyzer adapted to irradiate the liquid sample with light at the second wavelength.

42. The system of claim 41, wherein the data process comprises a predictor and a comparator, the predictor coupled with the first spectroscopic sample analyzer, the predictor adapted to predict the expected optical property at the second wavelength using the first optical property, the comparator coupled with the second sample analyzer, the comparator configured to compare the second optical property with the expected optical property and to determine whether a difference therebetween is above a predefined threshold.

43. The system of claim 42, which further comprises:
means for generating a warning signal if the difference between the second optical property and the expected optical property exceeds a predetermined threshold.

44. The system of claim 40, which further comprises:
a first bubble removing apparatus adapted to remove any first bubbles having a characteristic size of less than a predefined value from the sample before the contamination level is measured.

45. The system of claim 44, wherein the first bubble removing apparatus comprises:
a chamber having a piston adapted to compress/decompress the liquid sample introduced thereto;
an inflow line connected to the chamber arranged on a first side of the chamber and adapted to supply the liquid sample to the chamber;
an outflow line connected to the chamber arranged on a second opposite side of the chamber and adapted to drain the liquid sample from the chamber; and
a bypass line connected to the chamber adapted to remove any bubbles from the liquid sample in the chamber.

46. The system of claim 45, wherein each of the inflow line, the outflow line and the bypass line includes a valve.

47. The system of claim 44, which further comprises:
a second bubble removing apparatus adapted to remove any second bubbles having a characteristic size of greater than or equal to the predefined value from the sample before the contamination level is measured.

48. The system of claim 47, wherein the second bubble removing apparatus is upstream from the first bubble removing apparatus.

49. The system of claim 40, which further comprises:
one or more pulsation absorption apparatuses in fluid communication with the analyzer, the one or more pulsation absorption apparatuses adapted to reduce a pulsation in the sample before the contamination level is measured.

50. The system of claim 49, wherein the one or more pulsation absorption apparatuses each include a pulsation absorption filter comprising an elastomer configured to absorb the pulsation.

51. A liquid sample analyzing system, comprising:
a liquid bath adapted to supply a liquid sample;
a liquid sample analyzer adapted to analyze an absorbency of the liquid sample induced by irradiating a light at particular wavelengths through the liquid sample to determine a contamination indication of particular contaminant in the sample;
a first bubble removing apparatus adapted to remove any bubbles of less than a defined characteristic size from the liquid sample before the liquid sample is introduced to the analyzer; and
one or more pulsation absorption apparatuses adapted to reduce a pulsation in the sample.

52. The system of claim 51, wherein the one or more pulsation absorption apparatuses each includes a pulsation absorption filter comprising an elastomer configured to absorb the pulsation, wherein the analyzer is in fluid communication with the one or more pulsation absorption apparatuses.

53. The system of claim 51, further comprising a second bubble removing apparatus adapted to remove any bubbles of greater than or equal to the characteristic size from the liquid sample before the liquid sample is introduced to the analyzer.

54. The system of claim 51, wherein the liquid sample analyzer comprises:
a light source;
a band-pass filter adjacent the light source, the filter adapted to allow only light having a particular wavelength to pass therethrough;
a flow cell structured and arranged to allow flow of liquid sample therethrough;
a lens disposed between the flow cell and the band-pass filter; and
a photodiode detector arranged and structured to measure an absorbency of the light passing through the liquid sample.

55. The system of claim 54, wherein the photodiode detector comprises a single photodiode array detector.

56. The system of claim 54, wherein the band-pass filter comprises magnesium oxide (MgO) adapted to allow only the light having a wavelength of about 320 nm to pass therethrough.

57. The system of claim 54, wherein the band-pass filter comprises quartz adapted to allow only the light having a wavelength of about 520 nm to pass therethrough.

58. The system of claim 54, wherein the liquid sample comprises a solution chosen from diluted HF, NH₄OH/H₂O₂/H₂O (SC1), HCl/H₂O₂/H₂O, HNO₃/HF/H₂O, HF/H₂O₂, HF/NH₄/H₂O₂, HFNH₄, HF/HNO₃/CH₃COOH, H₃PO₄, HNO₃/H₃PO₄/CH₃COOH, and ultra de-ionized water.

59. The system of claim 54, wherein the particular contaminant comprises one or more chosen from transition metals, aluminum, tungsten and titanium.
